(19) United States
(12) Patent Application Publication
(10) Pub. No.: US 2014/0191177 A1
(43) Pub. Date: Jul. 10, 2014

(54) CONNECTOR ASSEMBLIES

(71) Applicant: HOMECARE PRODUCTS, INC., Algona, WA (US)

(72) Inventor: David A. Bailie, Kent, WA (US)

(73) Assignee: Homecare Products, Inc., Algona, WA (US)

(21) Appl. No.: 13/735,999

(22) Filed: Jan. 7, 2013

(51) Int. Cl. E04H 17/24; B23P 11/00

(52) U.S. Cl. CPC E04H 17/24; B23P 11/00
USPC 256/67; 29/525.03

(57) ABSTRACT

A connection assembly, in accordance with one embodiment of the present disclosure, generally includes a first portion, wherein the first portion includes a body made substantially from plastic material and an adjustable interface made substantially from metal material, and a second portion couplable to the first portion.

### BACKGROUND

Modular ramp and platform assemblies generally may include deck surfaces, legs, and handrails. As seen in FIG. 1, these modular assemblies can be configured to provide ramping and horizontal deck surfaces to provide access, for example, if a user needs to travel from elevation A to elevation B, but is not able to traverse stairs or a steep slope to get there.

Because the modular assemblies typically change path directions, for example, switching back from a first direction to a second direction, the handrails are joined at connectors (such as elbows) to provide a continuous handrail, but also to accommodate these direction changes.

The modular assemblies and the handrails are typically made from metal, for example, extruded aluminum. From a manufacturing standpoint, plastic handrail connector assemblies are desirable; however, a plastic-to-metal connection is not reliable and has been found to become un-joined in modular assemblies, such as the ones described herein.

Therefore, there exists a need for a handrail connector assembly that has connection integrity, but is easy to manufacture. Embodiments of the present disclosure are directed to fulfilling this and other needs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a connection assembly is provided. The connection assembly generally includes a first portion, wherein the first portion includes a body made substantially from plastic material and an adjustable interface made substantially from metal material, and a second portion couplable to the first portion.

In accordance with another embodiment of the present disclosure, a connection assembly is provided. The connection assembly generally includes a first portion, wherein the first portion includes a body made substantially from plastic material and an adjustable interface made substantially from metal material, wherein the adjustable interface includes a wedge portion and an interface portion extending outwardly from the wedge portion, and wherein the wedge portion causes the interface to expand when a force is applied to the wedge portion. The connection assembly further includes a second portion couplable to the first portion.

In accordance with another embodiment of the present disclosure, a method of using a connection assembly is provided. The method generally includes obtaining a first portion having a first end and a second end, wherein the first portion includes a body made substantially from plastic material and an adjustable interface made substantially from metal material. The method further includes coupling the first portion to a first metal connecting member, including inserting the second end of the first portion into the first connecting member and adjusting the adjustable interface of the first portion to engage with the first connecting member. The method further includes obtaining a second portion, coupling the second portion to a connecting member, and coupling the first and second portions to each other.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is an isometric view of a ramp and platform assembly including a plurality of connector assemblies in accordance with embodiments of the present disclosure;

FIG. 2 is a close-up, isometric view of a handrail assembly of the ramp and platform assembly of FIG. 1;

FIG. 3 is an isometric view of a connector assembly of FIGS. 1 and 2 in accordance with one embodiment of the present disclosure;

FIG. 4 is an exploded view of a connector assembly of FIG. 3;

FIG. 5 is a partially exploded, isometric view of a connector assembly of FIG. 3 including handrail members attached;

FIGS. 6A and 6B are partial cross-sectional view of the connector assembly with handrail members attached, shown in FIG. 5;

FIG. 7 is an isometric view of a connector assembly of FIGS. 1 and 2 in accordance with another embodiment of the present disclosure; and

FIG. 8 is an exploded view of the connector assembly of FIG. 7.

### DETAILED DESCRIPTION

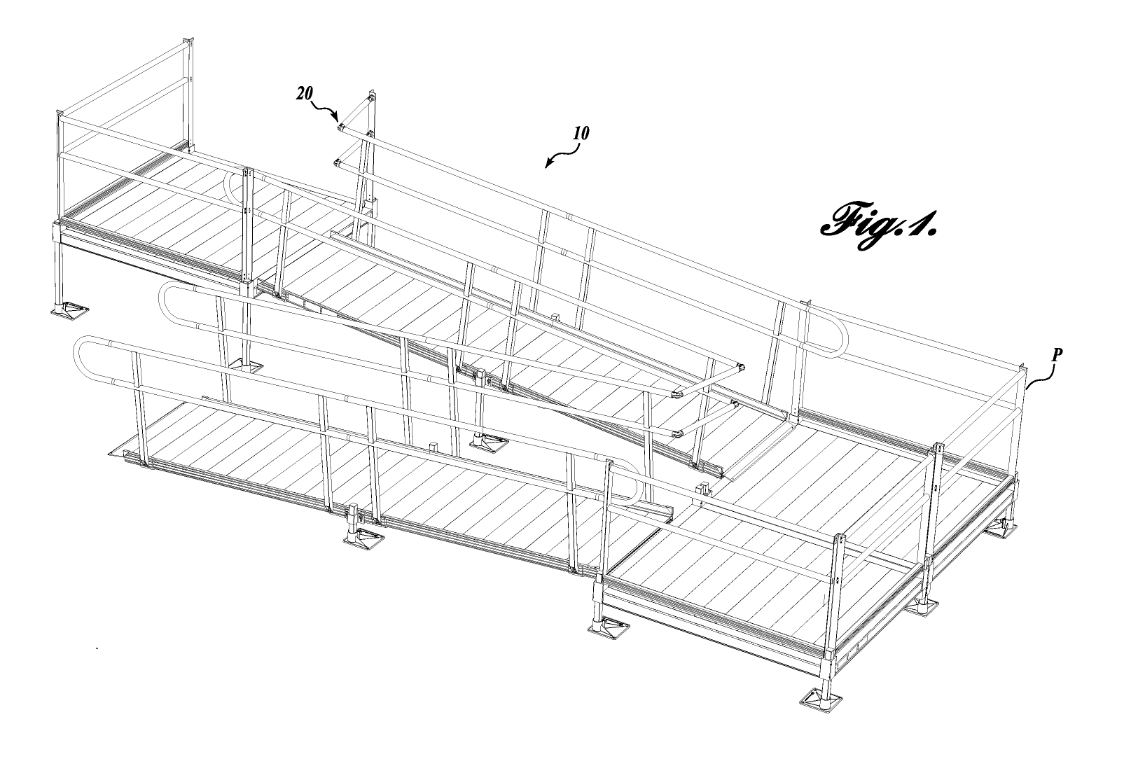

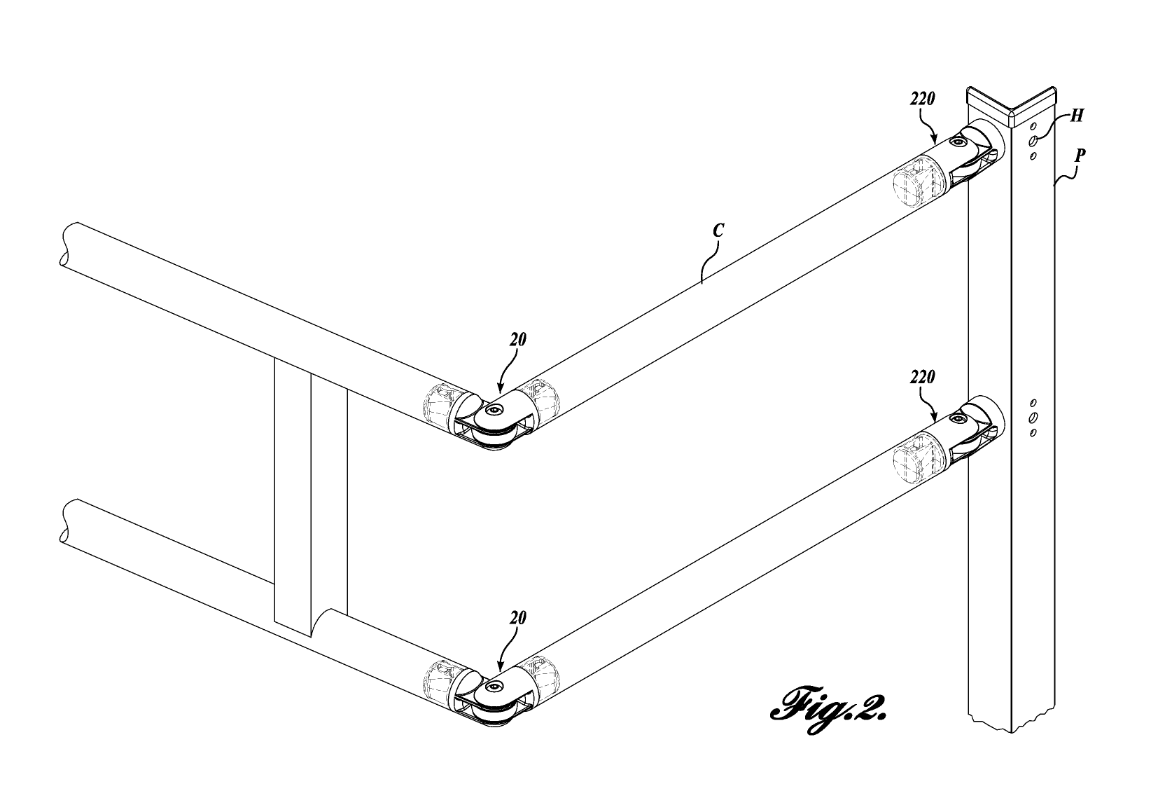

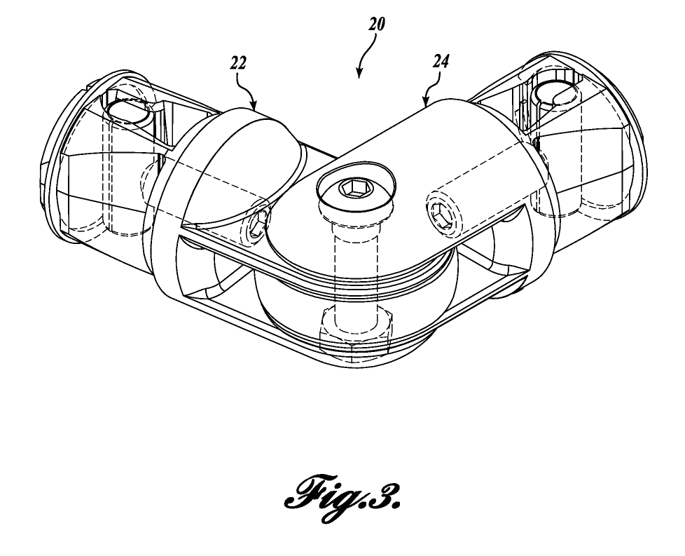

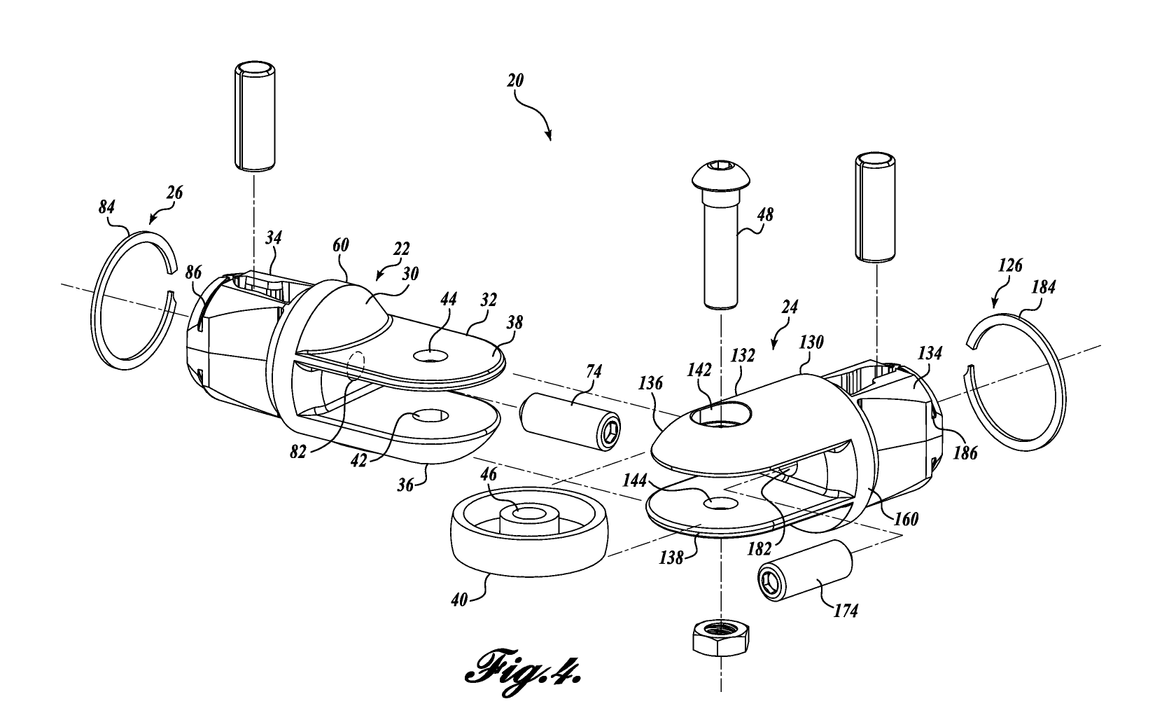

Embodiments of the present disclosure are generally directed to connector assemblies, for example, for use in connecting components of handrail assemblies that may be used in ramp and platform assemblies, as can be seen in FIGS. 1 and 2. Referring to FIGS. 3-6B, a connector assembly 20 in accordance with one embodiment of the present disclosure is shown. As can be seen in the exploded view of FIG. 4, the connector assembly 20 includes a first portion 22 couplable to a second portion 24. At least one of the first and second portions 22 and 24 includes an adjustable interface portion 26 for locking engagement with one or more metal connecting members C, such as a handrail member (see FIG. 2).

Although shown and described as being a handrail connector assembly, for example, for use in a ramp and platform assembly 10 (see FIG. 1), it should be appreciated that other types of uses for connector assemblies are also within the scope of the present disclosure, such as connecting any two tubes or pipes requiring adjustability in the pivot axis as well as the axial axis. The connector assemblies described herein can be installed without requiring holes, fasteners, or modifications to the connecting members that are being joined, and therefore both the connector assemblies and the connecting members can be reused or rejoined repeatedly. Further, it should be appreciated that embodiments of the connector assembly described herein may be sized and/or shaped to accommodate various different connecting members.

As described in greater detail below, many of the components of ramp and platform assembly may be formed from metal, for example, from extruded aluminum. Extruded aluminum construction generally reduces parts in the overall system, thereby reducing manufacturing and assembly costs, as well as operational noise generated by rattling part couplings. Moreover, extruded aluminum parts can be designed to achieve the same strength and stiffness requirements as steel construction, while having reduced weight over steel parts or parts made from other materials, allowing for improved ease of assembly and optimized part design.

As mentioned above, from a manufacturing standpoint, plastic connector assemblies are desirable because of their moldability. In that regard, moldability allows for production of parts in three dimensions, as compared to only two dimensions with extruded parts. Plastic parts also allow metal components to be molded into the part further reducing secondary steps required for assembly of non-moldable parts. However, a plastic-to-metal connection is not always reliable and has been found to become un-joined when subjected to loads as a result of stress relaxation in the plastic part. Therefore, the adjustable interface portion 26 of either of the first and second portions 22 and 24 has been designed to provide a more reliable metal-to-metal connection in a substantially plastic component.

In the illustrated embodiment of FIGS. 3-5, the first portion 22 includes a body 30, which may be made from plastic or from another non-metal material. The body 30 includes a first end 32 for engagement with the second portion 24, and a second end 34 for engagement with connecting members C, such as a handrail member.

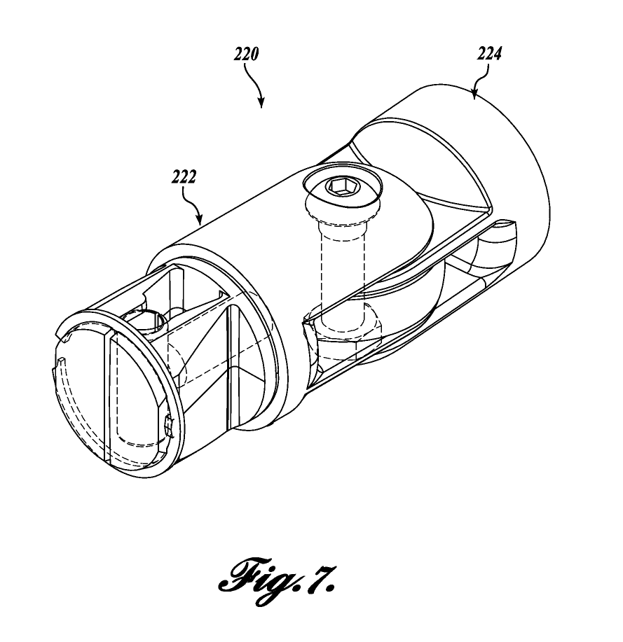

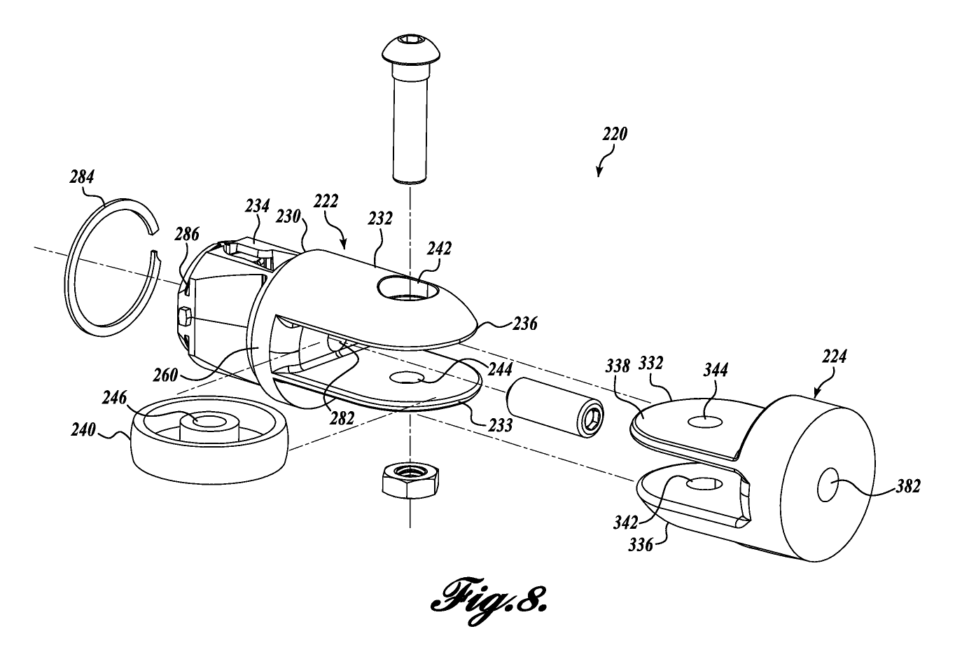

In the illustrated embodiment, the first and second portions 22 and 24 are substantially identical parts, each designed for engaging with respective connecting members C. However, it should be appreciated that in other embodiments of the present disclosure, the first and second portions need not be identical. For example, see the embodiment of FIGS. 7 and 8, as described in greater detail below. Because the first and second portions 22 and 24 are identical parts, components of the second portion 24 use similar reference numerals as components in the first portion 22, but in the 100 series.

As can be seen in FIG. 4, the first end 32 of the first portion 22 engages with the first end 132 of the second portion 24. The engagement between the first and second portions 22 and 24 provides for pivotable movement. In the illustrated embodiment, the first portion 22 includes first and second engagement arms 36 and 38 extending from base portion 60, and the second portion 24 includes first and second engagement arms 136 and 138 extending from base portion 160.

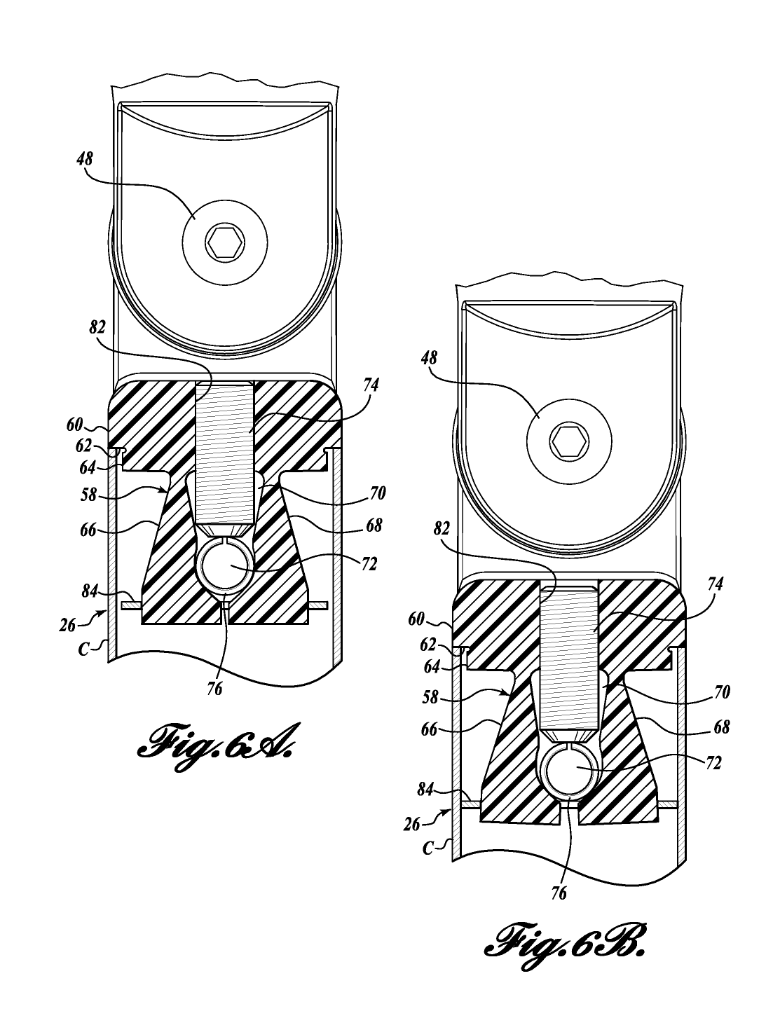

The respective engagement arms 36 and 38 and 136 and 138 are spaced from one another to allow for access of a tool (such as a screw driver or Allen wrench) to the respective base portions 60 and 160 between the engagement arms 36 and 38 and 136 and 138. Access of a tool allows for manipulation of other components of the connector assembly 20, such as a first pressing member 74, shown as a set screw, disposed in hole 82 (see FIGS. 6A and 6B), as will be described in greater detail below.

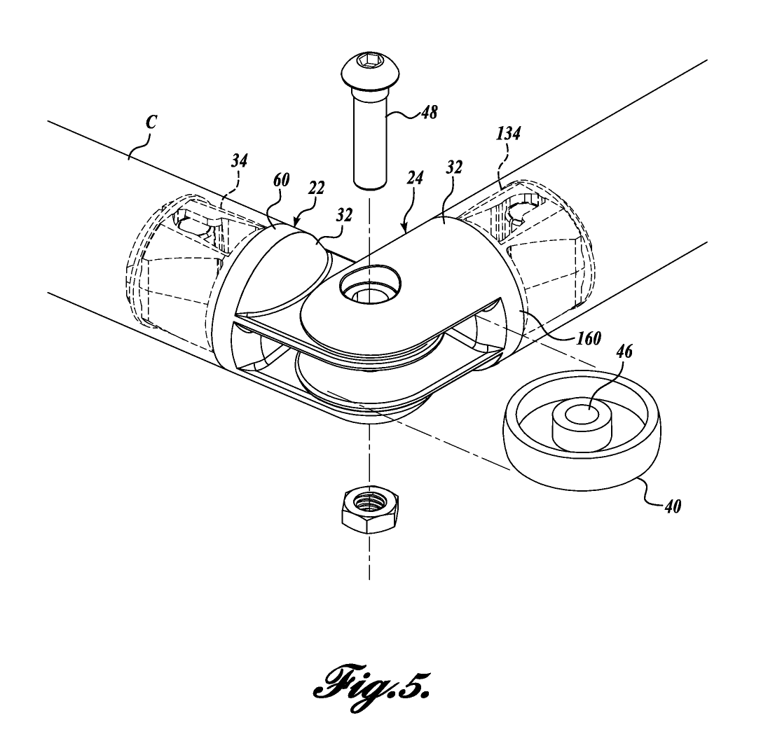

Referring to FIG. 5, when coupled, the first engagement arm 36 of the first portion 22 is positioned adjacent the second engagement arm 138 of the second portion 24. Likewise, the second engagement arm 38 of the first portion 22 is positioned adjacent the first engagement arm 136 of the second portion 24. A spacer 40 maintains the spacing between the engagement arms 36 and 138 and 38 and 136. Holes 42, 44, 142, 144, and 46 in the respective engagement arms 36, 38, 136, and 138 and the spacer 40 are configured for alignment and to receive a fastener 48 for attachment.

As can be seen in FIG. 5, the fastener 48 may be a removable fastener to allow for disassembly of the first and second portions 22 and 24 from each other to enable access between the engagement arms 36 and 38 and 136 and 138. In the illustrated embodiment, the fastener 48 is shown as a bolt and nut assembly; however, it should be appreciated that other types of fasteners may be within the scope of the present disclosure, such as self-locking connecting pins, roll pins, rivets, or any fasteners that can act as a pivot axle, etc.

In the illustrated embodiment, the first engagement arms 36 and 136 have contoured outer surfaces 50 and 150, designed to eliminate any sharp outer edges and to provide a comfortable gripping surface for a user (for example, when the connector assembly 20 is integrated into a handrail assembly). In contrast, the second engagement arms 38 and 138 have a uniform thickness so as to be received between the opposing first engagement arms 136 and 36 and the spacer 40. It should be appreciated, however, that the first engagement arms 36 and 136 need not have contoured outer surfaces 50 and 150 and, like the first and second engagement arms 36 and 38, may have a uniform thickness or any other suitable configuration.

Referring now to FIGS. 5, 6A, and 6B, the second ends 34 and 134 of the first and second portions 22 and 24 will now be described in greater detail. Because the first and second portions 22 and 24 are substantially identical parts, the discussion that follows will focus primarily on the second end 34 of the first portion 22.

The second end 34 includes a rim 64 defining an inner shoulder 62 that is recessed from the outer perimeter of the base portion 60. The shoulder 62 and recessed rim 64 are sized and configured to be received by an end of a connecting member C. However, the outer perimeter of the base portion 60 may be sized and configured to be equal to or larger than the outer perimeter of the connecting member C to provide a stop for the connecting member C. In the illustrated embodiment, the connecting member C is a hollow tubular member having an inner circular cross-sectional shape. However, it should be appreciated that the connecting member C need not be completely hollow, and may only have hollow ends for receiving the second end 34 of the connector assembly 20. Moreover, the connecting member C need not have an inner circular cross-sectional shape and may have any cross-sectional shape, for example, triangular, square, or another polygonal shape.

The second end 34 further includes a wedge portion 58 that is capable of wedging with the inner surface of the connecting member C to connect the connector assembly 20 and the connecting member C together. In the illustrated embodiment, the first and second extension portions 66 and 68 each have first and second ends. The first end is coupled to the base portion 60 of the connector assembly 20, and the second end is distal from the base portion 60. The first and second extension portions 66 and 68 extend from the base portion 60 and define first and second spaces 70 and 72 therebetween.

As discussed in greater detail below, the first and second extension portions 66 and 68 have some elasticity so as to be capable of moving relative to each other to change the sizing of the first and second spaces 70 and 72 (e.g., compare the distance between the first and second extension portions 66 and 68 in FIGS. 6A and 6B). In the illustrated embodiment, the first and second portions 66 and 68 each have an expanding cross-sectional width from the first ends to the second ends.

The first space 70 between the first and second extension portions 66 and 68 is configured to permit a first pressing member 74 to travel between the extension portions 66 and 68. In that regarding, the first space 70 has at least a minimum width throughout the space 70 to allow unobstructed passage the first pressing member 74.

The second space 72 is configured for holding a second pressing member 76. In that regard, the second space 72 is contoured to mate with the contours of the second pressing member 76. In the illustrated embodiment, the second space 72 is designed to hold a second pressing member 76 having a circular cross-section. Therefore, the contours of the inner surfaces of the tapered portions 66 and 68 are designed to be aligned with the contours of the second pressing member 76. At the distal ends of the tapered portions 66 and 68, the distance between the tapered portions is reduced as compared to the distance in the first and second spaces 72 and 70.

As first pressing member 74 extends into first space 70, force is exerted on the second pressing member 76, causing it to apply pressure to the tapered portions 66 and 68 and expand the distance between the tapered portions 66 and 68 (compare FIGS. 6A and 6B), thereby expanding the second space 72 and the distance between the distal ends of the tapered portions 66 and 68. Likewise, as first pressing member 74 retracts from first space 72, second pressing member 76 retracts to its original position (see FIG. 6A), as the tapered portions 66 and 68 return to their normal position.

In the illustrated embodiment, the first pressing member 74 is a threaded screw, such as a set screw, which is received in a threaded hole 82. As the first pressing member 74 is tightened into the hole 82, it exerts a force on the second pressing member 76, which is shows as a roll pin, for example, a steel roll pin. It should be appreciated that second pressing member 76 may also be a solid pin. It should further be appreciated that other pressing members are also within the scope of the present disclosure. For example, the wedge portion 58 of the second end 34 may be designed and configured such that the first pressing member 74 alone provide sufficient force to cause expansion of the second space 72 and the distance between the distal ends of the tapered portions 66 and 68.

Still referring to FIGS. 6A and 6B, the adjustable interface 26 of first portion 22 for engagement between the connector assembly 20 and the connecting member C will now be described in greater detail. In the illustrated embodiment, the adjustable interface 26 includes an interface portion 84 extending around the outer perimeter of the wedge portion 58, including first and second extension portions 66 and 68. The interface portion 84 is made substantially from metal materials for forming a reliable engagement with a metal connecting member.

In the illustrated embodiment, the interface portion 84 is a C-shaped ring (see FIG. 4), which may be configured to fit within a groove 86 extending along at least a portion of the outer perimeter of the first and second extension portions 66 and 68. Although shown as a ring in the illustrated embodiment, it should be appreciated that the interface portion 84 may be other suitable configurations that may be sized and configured to interact with the inner cross-sectional shape of the connecting member C.

As first pressing member 74 extends into first space 70, force is exerted on second pressing member 76, causing expansion of the second space 72 and the distance between the distal ends of the tapered portions 66 and 68 (compare FIGS. 6A and 6B). Such pressing force wedges the first and second extension portions 66 and 68 away from each other and causes the interface portion 84 to expand (see FIG. 6B) to engage with connecting member C. Such engagement creates an interference fit between the interface portion 84. When the first pressing member 74 retracts, the interface 26 also retracts to its unbiased position (see FIG. 6A).

The wedge portion 58 of the connector assembly 20 is designed to prevent stress relaxation and maintain a reliable connection between a substantially non-metal connector assembly 20 and metal connecting member C. In that regard, the design of the first and second portions 66 and 68 to each have expanding cross-sectional width from the first ends to the second ends reduces the chances of such stress relaxation. For example, the design allows for movability of the first and second portions 66 and 68 relative to each other at the first ends, but reduces the opportunity for stress relaxation across the width of the first and second portions 66 and 68 when the interface portion 84 is coupled with the connecting member C. Reducing the opportunity for stress relaxation at the second ends of the first and second portions 66 and 68 thereby reduces instances of decoupling between the connector assembly 20 and the connecting member C.

Moreover, the plastic of the first and second portions 66 and 68 of the connector assembly 20 may be specifically chosen to reduce stress relaxation problems.

In use, the first and second portions 22 and 24 of the connector assembly 20 are decoupled from one another, allowing access to the base portions 60 and 160 between the pairs of engagement arms 36 and 38 and 136 and 138. Each of the first and second portions 22 and 24 are coupled to respective connecting members C (as can be seen in FIG. 5). Referring to FIGS. 6A and 6B, when the first portion 22 (or the second portion 24) is coupled to a connecting member C, the second end 34 of the first portion 22 is inserted into the receiving portion of the connecting member C such that the end of the connecting member C is seated adjacent the base portion 60 of the first portion 22.

First pressing member 74 is adjusted to extend into first space 70 and force is exerted on second pressing member 76, causing it to expand (compare FIGS. 6A and 6B). Such expansion wedges the first and second extension portions 66 and 68 away from each other and causing the adjustable interface 26 to expand (see FIG. 6B) to engage with connecting member C.

After the first and second portions 22 and 24 of the connector assembly 20 have been coupled to respective connecting members C, the portions 22 and 24 can then be coupled to each other to complete the connection.

Although shown and described as a connecting assembly 20 having substantially identical first and second portions 22 and 24, it should be appreciated that other connecting assemblies having non-identical portions are also within the scope of the present disclosure. Referring now to FIGS. 7 and 8, an alternate embodiment of a connecting assembly 20 will be described. The connecting assembly 220 of FIGS. 7 and 8 is substantially similar to the connecting assembly 20 of FIGS. 3-6B, except for differences regarding the second portion of the connecting assembly 220. Like numerals are used for the connecting assembly 220 of FIGS. 7 and 8 as used for the connecting assembly 20 of FIGS. 3-6B but in the 200 series.

In the illustrated embodiment of FIG. 8, the connector assembly 220 includes a first portion 222 for connecting with a connecting member C, similar to the first portion 22 of the connector assembly 20 described with reference to FIGS. 3-6B. However, the second portion 224 of the connector assembly 220 is not configured to connecting with a connecting member C as seen in FIGS. 3-6B, but rather is configured for connecting with a connecting member shown as post P, as can be seen in FIGS. 1 and 2. The second portion 224 can be coupled directly to a post P using a fastener system, such as a nut and bolt system through hole 382, to couple with a post hole H (see FIG. 2).

While illustrative embodiments have been illustrated and described, it will be appreciated that various changes can be made therein without departing from the spirit and scope of the disclosure.

1. A connection assembly, comprising:
(a) a first portion, wherein the first portion includes a body made substantially from plastic material and an adjustable interface made substantially from metal material; and
(b) a second portion couplable to the first portion.

2. The connection assembly of claim 1, wherein the adjustable interface includes a wedge portion.

3. The connection assembly of claim 2, wherein the wedge portion expands and contracts when subjected to a force.

4. The connection assembly of claim 3, wherein the force is applied to the wedge portion by one or more pressing members.

5. The connection assembly of claim 3, wherein the adjustable interface further includes an interface portion extending outwardly from the wedge portion.

6. The connection assembly of claim 5, wherein the interface expands and contracts together with the wedge portion.

7. The connection assembly of claim 1, wherein the first and second portions are pivotably coupled to one another.

8. The connection assembly of claim 1, wherein the first and second portions include respective first and second engagement arms for coupling with one another.

9. The connection assembly of claim 8, wherein the first and second engagement arms of the first portion are spaced apart from one another.

10. The connection assembly of claim 9, wherein the spacing between the first and second engagement arms provides access to adjust the adjustable interface of the first portion.

11. The connection assembly of claim 1, wherein the second portion is substantially similar to the first portion.

12. The connection assembly of claim 1, wherein the second portion is different from the first portion.

13. A connection assembly, comprising:
(a) a first portion, wherein the first portion includes a body made substantially from plastic material and an adjustable interface made substantially from metal material, wherein the adjustable interface includes a wedge portion and an interface portion extending outwardly from the wedge portion, and wherein the wedge portion causes the interface to expand when a force is applied to the wedge portion; and
(b) a second portion couplable to the first portion.

14. A method of using a connection assembly, the method comprising:
(a) obtaining a first portion having a first end and a second end, wherein the first portion includes a body made substantially from plastic material and an adjustable interface made substantially from metal material;
(b) coupling the first portion to a first metal connecting member, including inserting the second end of the first portion into the first connecting member and adjusting the adjustable interface of the first portion to engage with the first connecting member;
(c) obtaining a second portion;
(d) coupling the second portion to a connecting member; and
(e) coupling the first and second portions to each other.

15. The method of claim 14, wherein the second portion has a first end and a second end, and wherein the second portion includes a body made substantially from plastic material and an adjustable interface made substantially from metal material.

16. The method of claim 15, further comprising coupling the second portion to a second metal connecting member, including inserting the second end of the second portion into the second connecting member and adjusting the adjustable interface of the second portion to engage with the second connecting member.
